(19) United States
(12) Patent Application Publication
(10) Pub. No.: US 2009/0241293 A1
(43) Pub. Date: Oct. 1, 2009

(54) Ergonomic handle system for work tool

(75) Inventor: David Swerdlick, Plymouth, MN (US)

Correspondence Address: Mark A. Litman & Associates, P.A., York Business Center, Suite 205, 3209 West 76th St., Edina, MN, 55435, US

(73) Assignee: Supertasty, Incorporated

(21) Appl. No.: 12/080,226

(22) Filed: Apr. 1, 2008

(51) Int. Cl. B25G 1/00

(52) U.S. Cl. 16/430

(57) ABSTRACT

An attachment is used with an appliance having a single shaft for gripping and manipulation of the appliance by a user. The attachment has a base having a first end and a second end, and a first side and a second side. On the base are two shaft-securing elements. There are a first shaft-securing element positioned towards the first end and a second shaft-securing element positioned towards the second end. There is a two-hand grip handle attached to the base intermediate the first shaft securing element and the second shaft-securing element.

### BACKGROUND OF THE INVENTION

1. Field of the Invention

The present invention relates to hand operated or hand powered apparatus in which users move and/or direct an active portion of the apparatus through a handle grasped and maneuvered by the user. In particular, the present invention relates to a handle system that can be grasped by both hands of the user in separate areas about a shaft.

2. Background of the Art

Appliances and hand tools tend to be used in specific modes and styles, even if the modes tend to be less than best from an ergonomic standpoint. Tension and repetitive stress tend to be placed on specific muscles, tendons and ligaments in a repeated manner because the design of the appliance or tool requires use in a particular way that places undesirable stress on specific portions of the human anatomy. Numerous design and structural changes have been made in appliances and tools to address some of the stressful uses of those appliances and tools.

U.S. Pat. No. 7,216,403 (discloses an ergonomic appliance handle that is an extension handle attachable to a carrying or transport handle on a canister style vacuum cleaner or similar floor appliance. The ergonomic appliance handle provides an elongated handle shaft that is attached to the canister vacuum's handle at a proximate end of the handle shaft by a mounting assembly. The handle shaft extends angled upward, away from the vacuum, placing a handgrip at the distal end of the handle shaft at an ergonomically comfortable height and position for a user to easily and conveniently operate the vacuum in a comfortable posture without subjecting the user to unnecessary bending, stooping, or twisting.

U.S. Pat. No. 6,742,222 (Furr-Britt et al.) discloses a dual handle attachment for an upright floor appliance. A single central bracket attaches to the conventional single handlebar of an appliance, such as an upright vacuum cleaner, with a left and a right handgrip adjustably extending from the central bracket. The dual handle attachment allows a user to maneuver the appliance using generally symmetric upper body, arm, wrist, and hand forces.

U.S. Pat. No. 3,897,607 (Schaffer et al.) discloses a readily removable implement handle for a vacuum cleaner, tool, floor scrubber, sweeper, or other device. Insertion means disposed on the handle releasably engage with receiving means affixed to the device, the handle including a locking means in the form of a spring.

U.S. Pat. No. 5,507,071 (Berfield) discloses a U-shaped handle that is attachable to a motor housing of a vacuum apparatus to carry or lift the appliance.

U.S. Pat. No. 5,819,364 (Sham) discloses a detachable handle accessory for a handheld portable steam vacuum cleaner. The handle accessory includes a support base for mounting the portable steam vacuum cleaner, a handle portion extending upwardly from the support base, and a wheel assembly affixed to the support base. The handle converts the handheld portable steam vacuum cleaner into an upright steam vacuum cleaner.

U.S. Patent Application Publication 2002/0124347 (Roney et al.) discloses a telescoping handle built into an upright vacuum cleaner.

U.S. Patent Application Publication No. 2002/0124345 (Holsten et al.) discloses a vacuum appliance having push and pull handles. The vacuum cleaning appliance is generally of the canister vacuum configuration. A first handle is disposed on a first side of the vacuum appliance, a second handle being disposed on a second side of the vacuum appliance generally opposite the first side.

U.S. Patent Application Publication 2003/0101534 (Noreen et al.) discloses a canister-type vacuum cleaner having a collapsible handle attached to the housing that is adjustable to the height of a user and positioned so that the user can use the handle to move and guide the vacuum cleaner housing.

Additional improvements are needed in ergonomic designs for hand operated appliances and tools, and add-on appliance handling systems are also desired.

### SUMMARY OF THE INVENTION

A handle attachment is provided for addition to existing apparatus or appliance with push handles on them. The attachment provides two handles (one left hand and one right hand) for use by an appliance operator. The attachment will have at least two regions of securement to the existing push handle on the appliance or apparatus, one region relatively proximal to the user along the existing push handle and the other region more distal from the user and the two regions being on opposite sides of the handles added by the attachment. The handles in the attachment may also fold during storage.

An attachment is used with an appliance having a single shaft for gripping and manipulation of the appliance by a user. The attachment has a base having a first end and a second end, and a first side and a second side. On the base are two shaft-securing elements. There are a first shaft-securing element positioned towards the first end and a second shaft-securing element positioned towards the second end. There is a two-hand grip handle attached to the base intermediate the first shaft securing element and the second shaft-securing element.

### BRIEF DESCRIPTION OF THE FIGURES

FIG. 1 shows a side view of an ergonomic handle attachment for a single hand manipulated appliance or tool.

FIG. 2 shows a top view of an ergonomic handle attachment for a single hand manipulated appliance or tool.

### DETAILED DESCRIPTION OF THE INVENTION

A handle attachment is provided for tools or appliances, such as by way of non-limiting examples, vacuum cleaners, floor washers, floor waxers, mops, electric mops, sanders, floor polishers, floor sanders, and the like. The previous appliances (the term appliances is used herein to cover all such appliances and tools and devices as can be envisioned for use in combination with the invention described herein) and the appliances of choice to which the attachment is preferably provided typically have a stem, post or elongated handle with a single hand grip thereon. The attachment described herein is associated with and secured to the handle of the standard or prior art appliance, and the handle attachment can then be held by two hands to allow the user to control, move, direct and manipulate the device with two relatively symmetrical applications of force through two hands, rather than placing all usage stress on a single hand.

An attachment is used with an appliance having a single shaft for gripping and manipulation of the appliance by a user. The attachment has a base having a first end and a second end, and a first side and a second side. On the base are two shaft-securing elements. There are a first shaft-securing element positioned towards the first end and a second shaft-securing element positioned towards the second end. There is a two-hand grip handle attached to the base intermediate the first shaft securing element and the second shaft-securing element. The attachment may have:

a) the two-hand grip handle with a freedom of rotation about its axis;

b) each of the two shaft-securing elements comprising a support on the base and a strap passing through the support;

c) there is a locking element on the strap;

d) the base is flexible to enable adjustment to single shafts of different sizes;

e) the base is linear between the first end and the second end;

f) a slice through the base between the first end and the second end provides an arcuate cross-section; and

g) the two-hand grip is adjustable on the base in a direction between the first end and the second end.

The application of the present device to a vacuum cleaner will be discussed in greatest detail, and this discussion must be considered as a single device/appliance example within the generic scope of use of the present invention and not as a general limitation on the field of practice for the invention.

Looking at the Figures will assist in appreciating and understanding the practices of the technology and invention described herein.

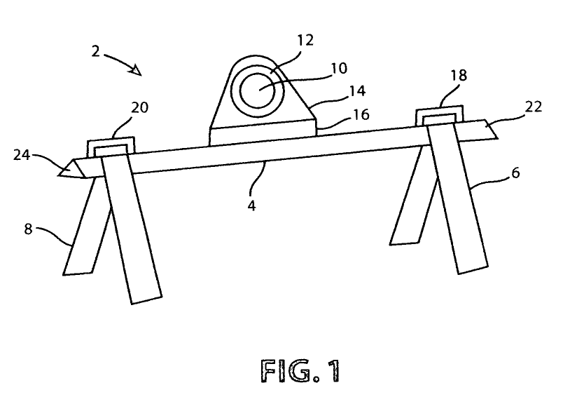

FIG. 1 shows a side view of an ergonomic handle attachment 2 for a single hand manipulated appliance or tool. The attachment 2 has a base 4 and an upper end 22 on the base 4 and a lower end 24 on the base 4. These “ends” may be interchangeable and the device symmetrical. On the upper end 22 is an attachment/securing system 18 shown as a strap guide and a strap 6. The strap 6 may have clips, snaps, fabric locks (e.g., Velcro® fasteners), buckles snake locks and the like to tighten the strap 6 and secure the base 4 to a handle on an appliance. On the lower end 24 is an attachment/securing system 20 shown as a strap guide and a strap 8. The base 4 may be rigid, linear and shaped (e.g., one face is arcuate) to accommodate a traditional straight handle (e.g., broom stick), or the base 4 may be uniquely shaped (sinusoidal, curved, angled, etc.) to fit a specific appliance handle, or the base 4 may be sufficiently flexible as to accommodate different shapes and sizes of handles on various appliance and handles on the appliances of different sizes and shapes.

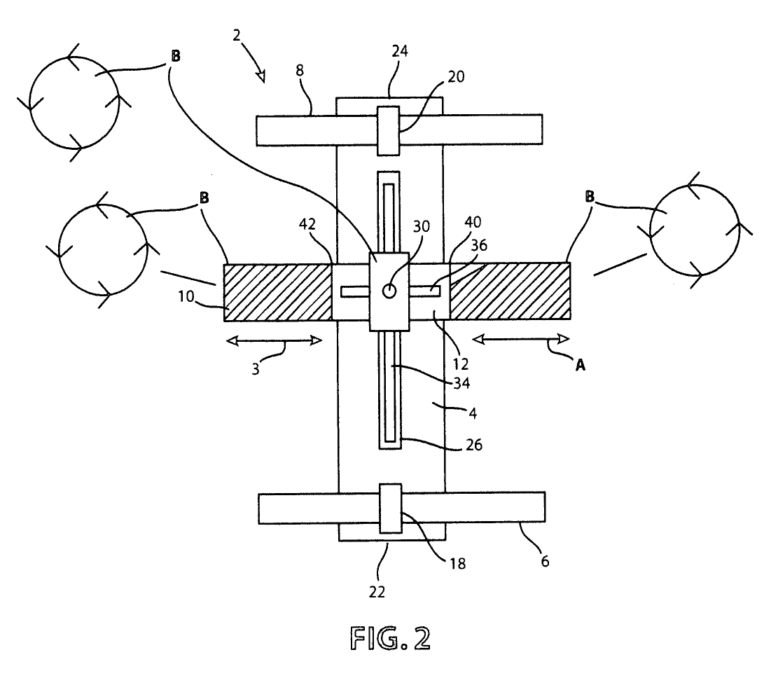

FIG. 2 shows a top view of an ergonomic handle attachment 2 for a single hand manipulated appliance or tool. Like numbers in the Figures refer to like elements in all figures. As seen from this top view, the straps 6 and 8 are towards opposite ends 22 and 24 of the base 4. The base 4 may be flexible (but stiff enough to resist distortion and slipping off a handle to which it is attached) and may be made of metal, wood, plastic, composite and the like. The attachment systems 18 and 20 may be permanently on the base 4 or may be replaceable with snaps, screws or the like. The attachment 2 handle 10 may be secured through a collar, brace or sleeve 12 and a pin or handle securing element 30 that passes into or through at least the collar 12 and optional longitudinal support 26 to assist in stabilizing the attachment 2 and optionally providing horizontal adjusting capability along glide 36 and vertical adjustability along glide 34, the optional glide 34 being in vertical track 32 and the optional horizontal glide 36 being in the collar 12. The handle 10 is shown with a capability of two-way rotation A so that when users are manipulating the appliance with the handle 10, the handle 10 can rotate to further reduce stress on the hands, wrist and arms of the user. The position of the handle 10 on the base 4 may be adjusted forward and sideways through the grooves 34 and 36. The handle 10 may also be allowed (as an option) to pivot about the securing element 30. The optional longitudinal support 26 may also rotate clockwise or counterclockwise as illustrated in rotation illustration B.

Another option in the construction of the attachment is shown in FIG. 2. Pockets or chambers 44 and 46 are shown in the base 4 (or they may alternatively be in the shaft (not shown) of the appliance (not shown) for receiving the ends of the handle 10 as it is folded along lines 40 and 42 with hinges or other moving connectors.

The attachment 2 as described herein may be used on any device or appliance where there is presently a single handle used to control or push the device. The most readily acceptable use is on a vacuum cleaner. In the normal use of a vacuum cleaner, there is a single shaft with a single grip for use by a single hand. Any attempt to use two hands would require a baseball or golf grip with hands at different levels on the shaft (thereby putting the arms and shoulders of the user out of alignment) or by having the hands on top of each other, which is an ineffective working position. The present technology allows for immediate and simple conversion of existing equipment to a two-hand system, with relatively parallel or symmetrical application of force by the user. I practice, the user will still place one foot in front of the other to advance the vacuum cleaner, but the shoulders and arms may remain somewhat symmetrical, and by allowing some pivoting and/or rotational action in the handles (as explained above), stress will be reduced.

What is claimed:

1. An attachment for use with an appliance having a single shaft for gripping and manipulation of the appliance by a user, the attachment comprising:
a base having a first end and a second end, and a first side and a second side:
on the base, two shaft-securing elements, a first shaft-securing element positioned towards the first end and a second shaft-securing element positioned towards the second end;
a two-hand grip handle attached to the base intermediate the first shaft securing element and the second shaft-securing element.

2. The attachment of claim 1 wherein the two-hand grip handle has a freedom of rotation about its axis.

3. The attachment of claim 1 wherein each of the two shaft-securing elements comprises a support on the base and a strap passing through the support.

4. The attachment of claim 3 wherein there is a locking element on the strap.

5. The attachment of claim 1 wherein the base is flexible to enable adjustment to single shafts of different sizes.

6. The attachment of claim 1 wherein the base is linear between the first end and the second end.

7. The attachment of claim 1 wherein a slice through the base between the first end and the second end provides an arcuate cross-section.

8. A vacuum cleaner having the attachment of claim 1 secured to a shaft of the vacuum cleaner as the single shaft.

9. A polishing machine having the attachment of claim 1 secured to a shaft of the polishing machine as the single shaft.

10. The attachment of claim 1 wherein the two-hand grip is adjustable on the base in a direction between the first end and the second end.
